(19) United States
(12) Patent Application Publication
(10) Pub. No.: US 2009/0094550 A1
(43) Pub. Date: Apr. 9, 2009

(54) ZOOMING METHOD OF DISPLAY IMAGE OF ELECTRONIC DEVICE

(75) Inventors: Yun-Liang HUANG, Taipei (TW); Huan-Chung HSU, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INVENTEC CORPORATION, Taipei (TW)

(21) Appl. No.: 12/194,374

(22) Filed: Aug. 19, 2008

(30) Foreign Application Priority Data
Oct. 3, 2007 (TW) 096137148

(51) Int. Cl. G06F 15/16

(52) U.S. Cl. 715/801

(57) ABSTRACT

A zooming method of a display image of an electronic device for zooming in a designated area of a portable electronic device. The zooming method includes the following steps setting a hot key combination, and loading a trigger event of the hot key into a Windows operating system as a monitor event; detecting the trigger event of an input device; if the Windows operating system detects the trigger event of the hot key, the Windows operating system executing a zooming process of the Windows operating system, so as to zoom in or zoom out the display image. Thus, a same set of hot key signals can be used to zoom in/out the designated area in different applications.

### CROSS-REFERENCE TO RELATED APPLICATIONS

This non-provisional application claims priority under 35 U.S.C. §119(a) on Patent Application No(s). 096137148 filed in Taiwan, R.O.C. on Oct. 3, 2007 the entire contents of which are hereby incorporated by reference.

### BACKGROUND OF THE INVENTION

1. Field of Invention

The present invention relates to a zooming method of a display image of an electronic device, and more particularly to a method for zooming in/out a designated area in a display unit of a portable electronic device.

2. Related Art

Many electronic devices, such as laptops, tablet computers, Ultra Mobile PCs (UMPCs), or PDA mobile phones, are becoming light, thin, short and small, such that they can be carried more conveniently. In addition to providing applications or functions of normal desktop computers, these products additionally have independent display units. Users can operate the electronic products or observe the application operation state in them through the display units. However, in order to satisfy the requirement on convenient carriage, the display units often use small LCD screens. However, too small screens make some of the users have difficulties in reading, so it is a new subject to improve the readability of the display units.

Taking a laptop for example, if a small display unit uses a high resolution, users has difficult to view information in the display unit. Therefore, the concept of adding the zooming in/out function into applications is developed. Through the zooming in/out function of the application, users can zoom in/out the information to be read to the size they are used to. For example, in Firefox browser, when users want to zoom in/out the content of a webpage, they just need to press the Ctrl key and scroll the mouse wheel to zoom in/out the content of the webpage.

However, different applications set different hot keys for the zooming function, and each application often defines a specific hot key for the zooming function. Moreover, the hot keys for the zooming function are often composite keys involving a plurality of keys. Therefore, it is impossible for users to remember all of the composite keys. Though the applications have the zooming function, it cannot be utilized by the users conveniently.

### SUMMARY OF THE INVENTION

In view of the above problem, the present invention is directed to providing a zooming method of a display image of an electronic device, for zooming in a designated area of a portable electronic device.

In order to achieve the above objective, the zooming method of a display image of an electronic device of the present invention includes the following steps: setting a hot key combination, and loading a trigger event of the hot key into a Windows operating system as a monitor event; detecting the trigger event of an input device; if the Windows operating system detects the trigger event of the hot key, the Windows operating system executing a zooming process of the Windows operating system, so as to zoom in or zoom out the display image.

The present invention detects a hot key signal sent from a keyboard, and triggers a mouse key zooming event, so as to zoom in/out the image of an area where a mouse cursor is located. Thus, a same hot key can be used to zoom in/out images in different applications.

As for features and examples of the present invention, a preferred embodiment will be illustrated in detail with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a flow chart of the operating process of the present invention;

FIG. 2A is a schematic view of the browser content before zooming;

FIG. 2B is a schematic view of the browser content after zooming;

FIG. 3A is a schematic view of zooming font images according this embodiment;

FIG. 3B is a schematic view of zooming font images according this embodiment;

FIG. 4A is a schematic view of zooming picture images according this embodiment;

FIG. 4B is a schematic view of zooming picture images according this embodiment;

FIG. 5A is a schematic view of zooming word images according this embodiment;

FIG. 5B is a schematic view of zooming word images according this embodiment;

FIG. 6A is a schematic view of zooming font images according this embodiment;

FIG. 6B is a schematic view of zooming font images according this embodiment;

FIG. 7A is a schematic view of zooming picture images according this embodiment;

FIG. 7B is a schematic view of zooming picture images according this embodiment;

FIG. 8A is a schematic view of zooming word images according another embodiment;

FIG. 8B is a schematic view of zooming word images according another embodiment;

FIG. 9A is a schematic view of zooming font images according another embodiment;

FIG. 9B is a schematic view of zooming font images according another embodiment;

FIG. 10A is a schematic view of zooming picture images according another embodiment; and

FIG. 10B is a schematic view of zooming picture images according another embodiment.

### DETAILED DESCRIPTION OF THE INVENTION

The present invention provides a zooming method of a display image of an electronic device, which is applicable to a display unit of a portable electronic device. The portable electronic device can be a laptop, a tablet computer, a Ultra Mobile PC (UMPC), or a PDA mobile phone.

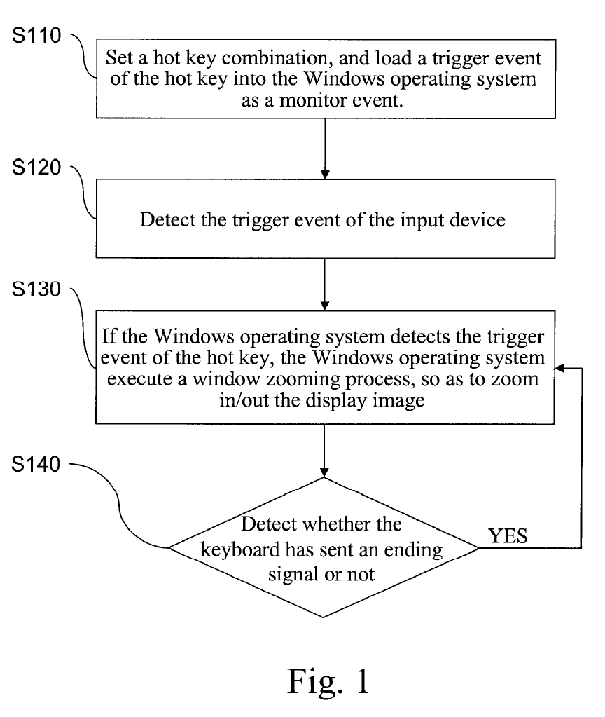

In this embodiment, a Microsoft Windows operating system is taken as an example. Referring to FIG. 1, a flow chart of the operating process of the present invention is shown. Firstly, a hot key combination is set, and a trigger event of the hot key is loaded into the Windows operating system as a monitor event (step S110). The trigger mode of the hot key is an external interruption. In other words, the trigger mode can be regarded as a program retain in the Windows operating system, which waits for being triggered by the trigger event of the hot key. To monitor the trigger event that corresponding to the hot key from an input device(step S120). Here, the hot key can be composite keys or a single key or mouse wheel. If the Windows operating system detects the trigger event of the hot key, the Windows operating system executes a window zooming process, so as to zoom in/out the display image (step S130). A PC then triggers events of window display and window drawing according to an interrupter sent from the input device.

Next, it is detected whether the keyboard sends an ending signal or not (step S140). If the ending signal is detected, then the zooming in process is ended, and step S130 is repeated. If no ending signal is detected, then step S140 is repeated.

In the present invention, as the hot key signal sent from the keyboard is a hardware interrupter, when an application being executed now has the same hot key, the operating system will regard the hardware interrupter sent from the keyboard as a priority, and will block hot key signals sent by the application. Thus, it is prevented to start the corresponding function of the same hot key of the application when the hot key is pressed.

In this embodiment, the hot key is a combination of different keys of the keyboard. In order to illustrate this embodiment more conveniently, the hot key is defined as “Ctrl”+“Page Up” here. However, the hot key certainly can be a combination of other keys.

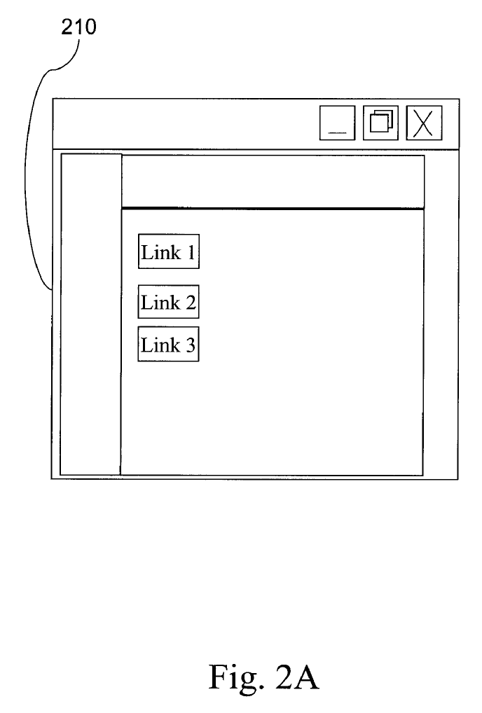

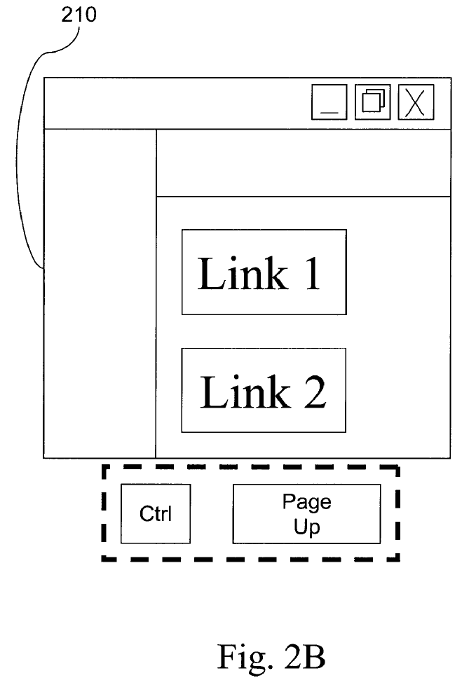

FIGS. 2A and 2B are schematic views of the browser content before and after zooming respectively. A preferred embodiment of the present invention will be illustrated with reference to FIGS. 2A and 2B. FIG. 2A shows a display image of a browser, in which “link 1”, “link 2”, and “link 3” are shown. When a user presses the hot key “Ctrl”+“Page Up”, the operating system detects that the hot key signal “Ctrl”+“Page Up” is input, and will perform zooming according to a preset magnification ratio and magnification area. In this embodiment, “link 1” and “link 2” in the image of FIG. 2A are enlarged to the size shown in FIG. 2B for the convenience of illustration. In other words, a partial area is played in the image of the entire display unit.

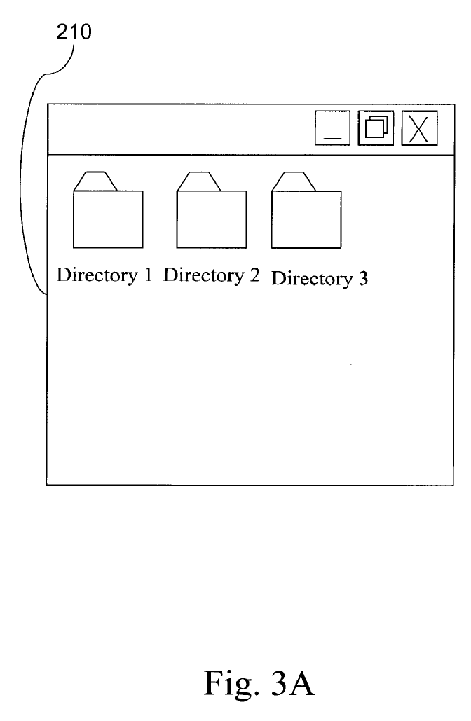

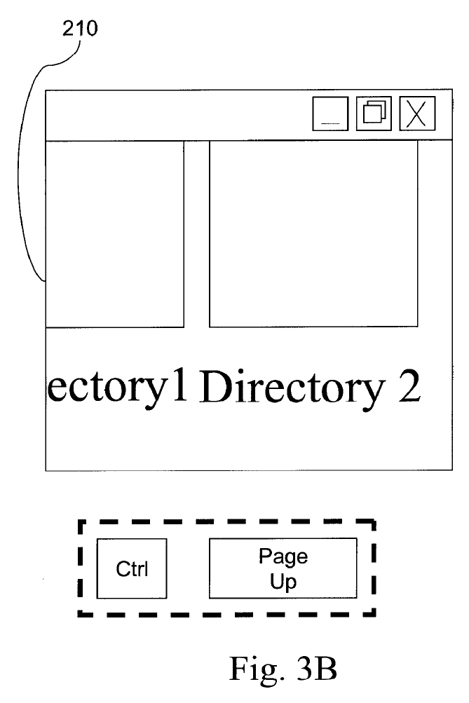

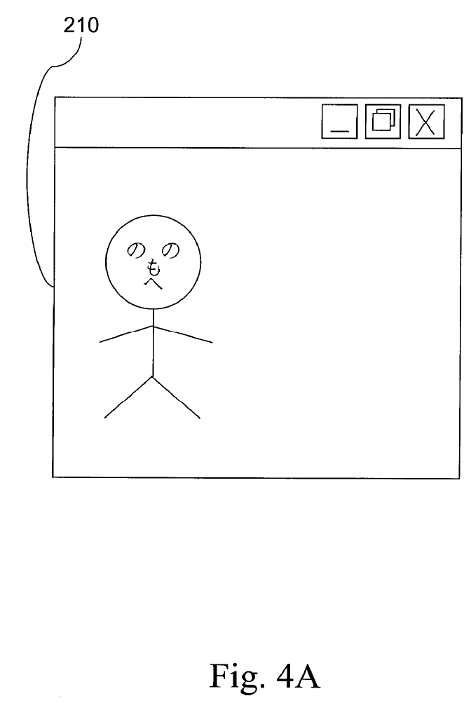

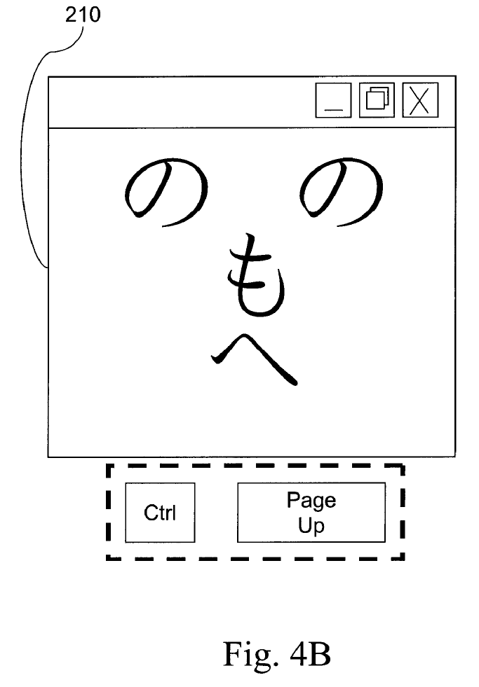

In addition, referring to FIGS. 3A, 3B, 4A, and 4B, schematic views showing the zooming of various images in this embodiment are shown. In addition to zooming in icons or words, the present invention can also zoom in/out pictures.

In another embodiment of the present invention, a partial area of the display image is zoomed in according to the position of a mouse cursor 300. Firstly, the image content of a first display area 220 is captured according to the position of the mouse cursor 300 as a center. Then, the image in the first display area 220 is redrawn in a second display area 230.

Provided that the first display area 220 is an area of 10*10 pixels, and the second display area 230 is a display window that has 30*30 pixels, the window content covered by the first display area 220 will be zoomed in by 9 times if being put into the second display area 230. Certainly, different display areas and display windows can be set according to display units 210 of different portable electronic devices.

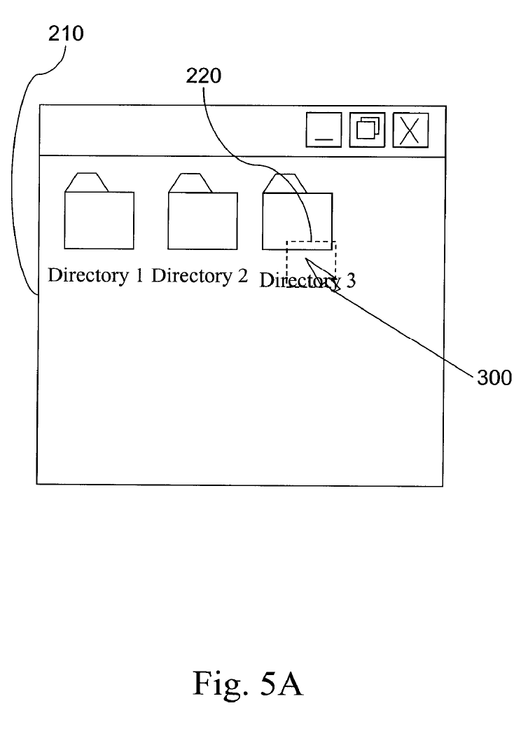

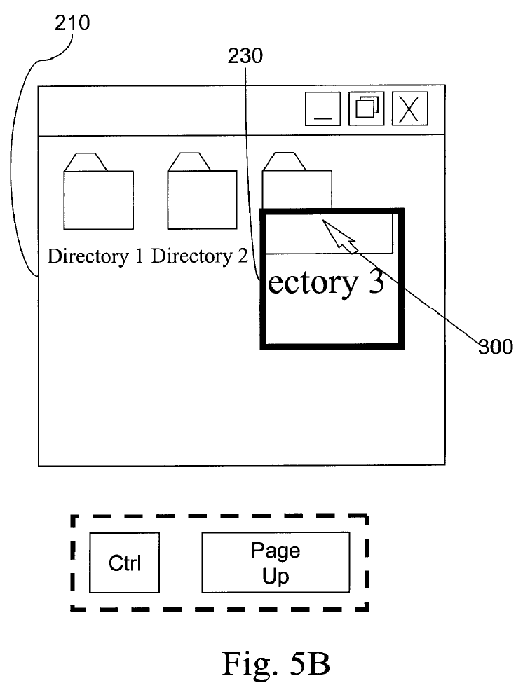

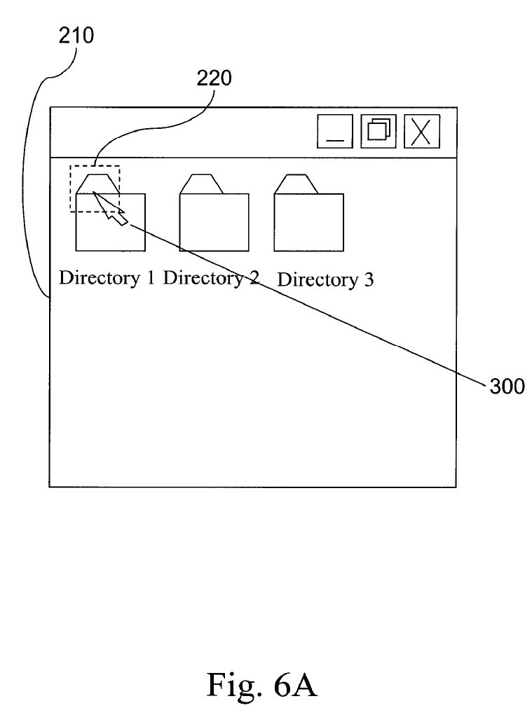

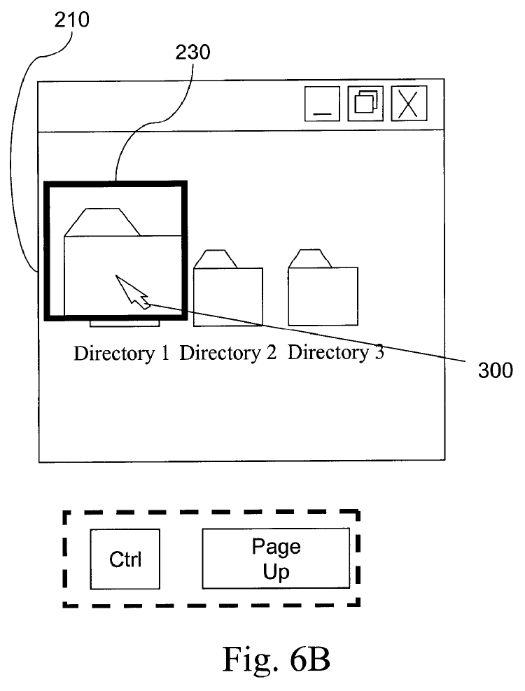

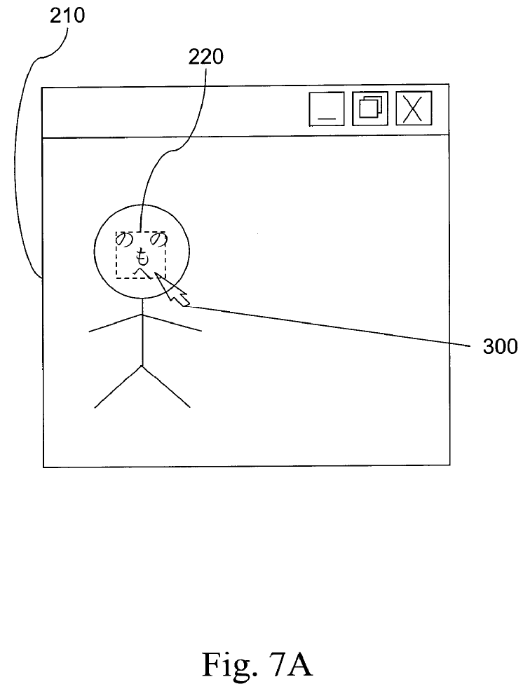

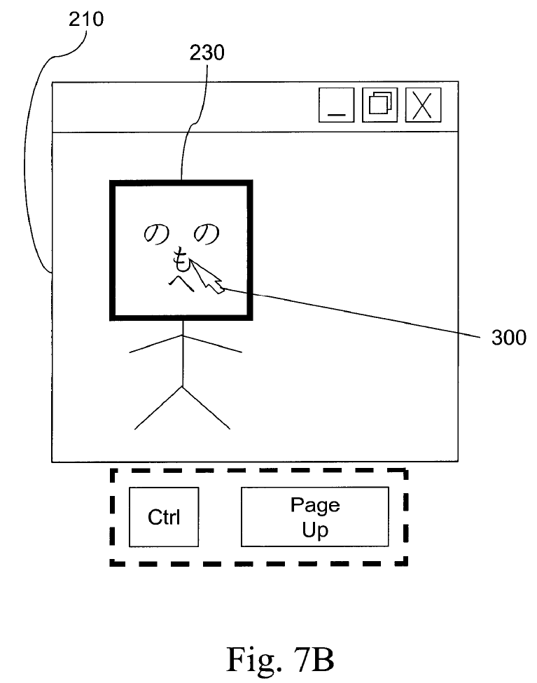

Referring to FIGS. 5A and 5B, schematic views of zooming a word image in this embodiment are shown. When the mouse cursor 300 of FIG. 5A is moved to “directory 3” in the image, the user presses the hot key “Ctrl”+“Page Up”. After the operating system detects that the hot key signal “Ctrl” +“Page Up” is input, the operating system will display the first display area 220 around the position of the mouse cursor 300 (the dashed frame in FIG. 5A) in the second display area 230 (the black frame in FIG. 5B). When the mouse cursor 300 moves to a different position, the operating system will zoom in the display according to the current position of the mouse cursor 300. In addition, referring to FIGS. 6A, 6B, 7A, and 7B, schematic views showing the zooming of various images in this embodiment are shown. In addition to zooming in icons or words, the present invention can also zoom in/out pictures.

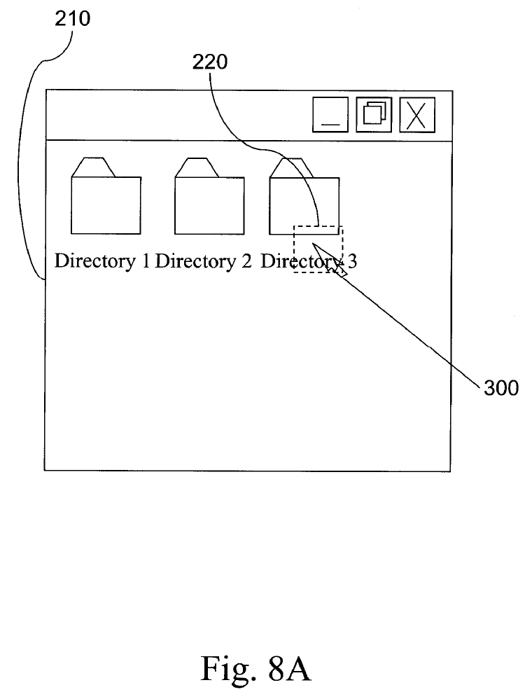

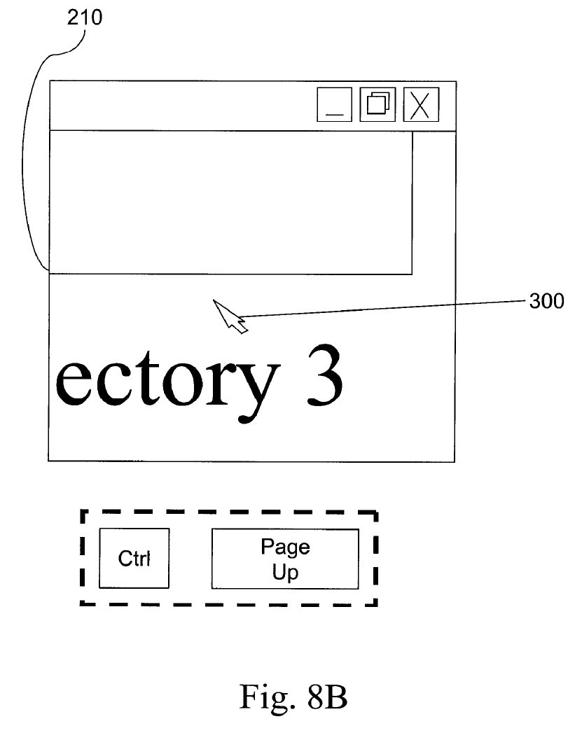

In another embodiment of the present invention, the current position of the mouse cursor 300 is zoomed in to the entire display image. The difference between this embodiment and the previous embodiment is as follows. In the previous preferred embodiment, the display area is zoomed in to a part of the display image, while in this embodiment, the display area is zoomed in to the entire display image. Firstly, the image content of the first display area 220 is captured according to the position of the mouse cursor 300 as a center. Then, the content of the first display area 220 is redrawn in the display unit 210. Here, it is assumed that the first display area 220 in this embodiment is still an area of 10*10 pixels. Referring to FIGS. 8A and 8B, schematic views of zooming a display image according to another embodiment are shown.

The mouse cursor 300 of FIG. 8A is moved to “directory 3” in the image, the user presses the hot key “Ctrl”+“Page Up” at the same time. After the operating system detects that the hot key signal “Ctrl”+“Page Up” is input, the operating system will display the first display area 220 around the position of the mouse cursor 300 (the dashed frame in FIG. 8A) in the display unit 210. When the mouse cursor 300 moves to a different position, the operating system will zoom in the display according to the current position of the mouse cursor 300.

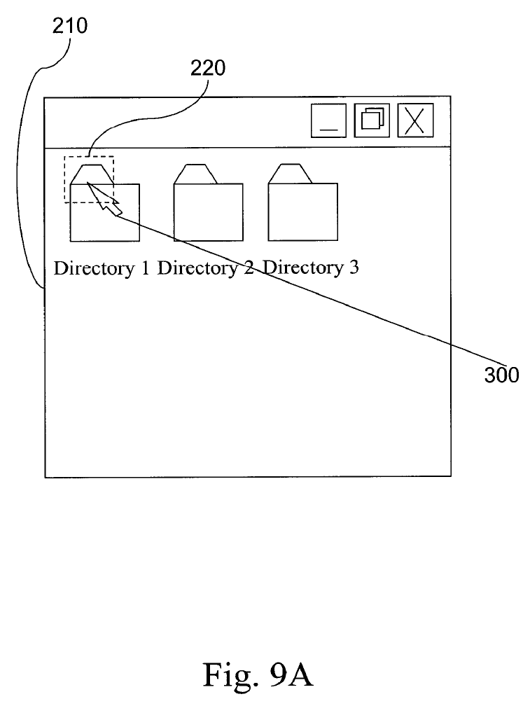

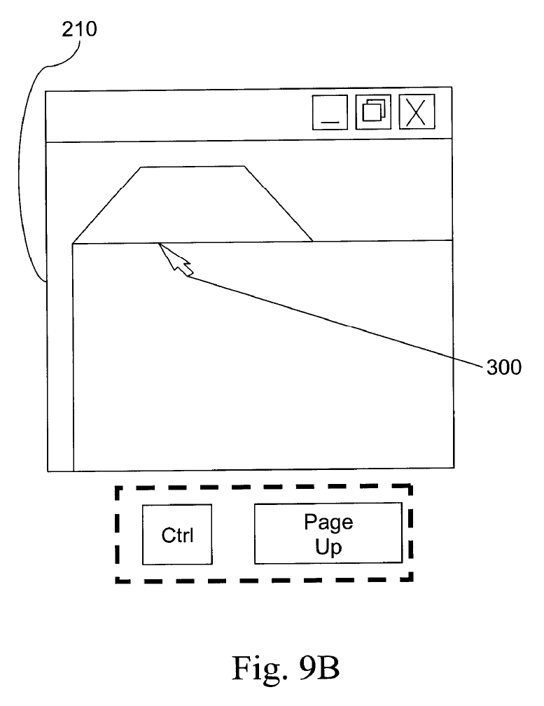

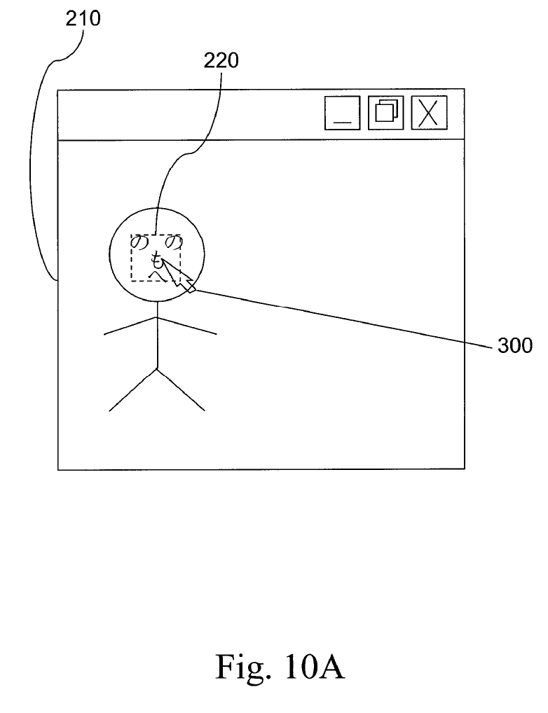

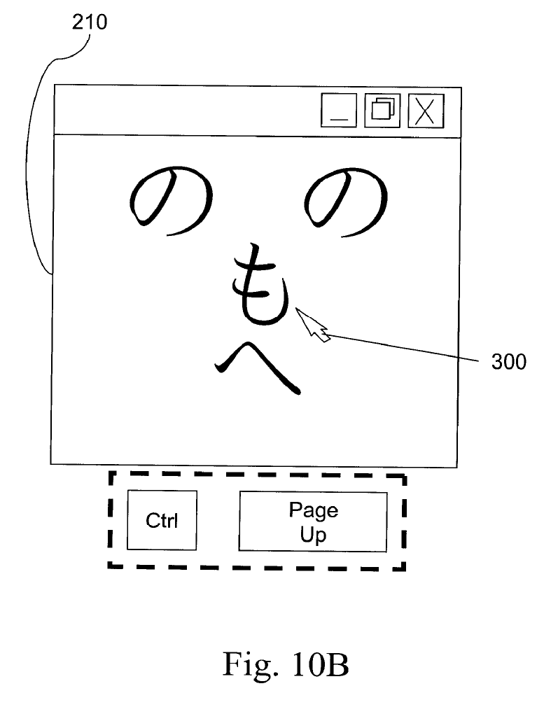

In addition, referring to FIGS. 9A, 9B, 10A, and 10B, schematic views showing the zooming of various images according to another embodiment are shown. In addition to zooming in icons or words, the present invention can also zoom in/out pictures.

According to the present invention, the operating system detects a hot key signal sent from the keyboard, and calls a hot key window zooming event, so as to zoom in/out the image of an area where the mouse cursor 300 is located. Thus, a same hot key can be used to zoom in/out images in different applications.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A zooming method of a display image of an electronic device, for zooming a designated area in the current display image of a portable electronic device, the zooming method comprising:
setting a hot key, and loading a trigger event of the hot key into a Windows operating system as a monitor event;
monitoring the trigger event of an input device; and
executing a window zooming process for zooming in/out the display image when the trigger event of the hot key is monitored.

2. The zooming method of a display image of an electronic device as claimed in claim 1, wherein a signal of the hot key is a hardware interrupter signal.

3. The zooming method of a display image of an electronic device as claimed in claim 1, wherein loading the monitor event into the Windows operating system is retain as a monitor process.

4. The zooming method of a display image of an electronic device as claimed in claim 1, further comprising:
capturing display content of a first display area, and redrawing the display content and displaying the display content in a second display area.

5. The zooming method of a display image of an electronic device as claimed in claim 4, wherein capturing the first display area further comprises:
capturing the first display area according to a position of a mouse cursor.

6. The zooming method of a display image of an electronic device as claimed in claim 4, wherein capturing the first display area further comprises:
capturing current display content of a display unit as the first display area.

7. The zooming method of a display image of an electronic device as claimed in claim 1, wherein the input device is a keyboard.

8. The zooming method of a display image of an electronic device as claimed in claim 1, wherein the input device is a mouse.

9. The zooming method of a display image of an electronic device as claimed in claim 1, wherein the hot key is a combination of composite keys.
